(19) United States
(12) Patent Application Publication
(10) Pub. No.: US 2026/0252386 A1
(43) Pub. Date: Aug. 27, 2026

(54) NEURAL PROCESSING CIRCUITS SUPPORTING CONTEXT SWITCHING

(71) Applicant: APPLE INC., Cupertino, CA (US)

(72) Inventors: Sayyed Karen KHATAMIFARD, Cupertino, CA (US); Chenfan SUN, Sammamish, WA (US); Sepideh Hassan MOGHADDAM, Cupertino, CA (US); Gokul KRISHNAN, Snohomish, WA (US)

(73) Assignee: APPLE INC., Cupertino, CA (US)

(21) Appl. No.: 19/060,342

(22) Filed: Feb. 21, 2025

(51) Int. Cl. G06F 9/48; G06N 3/063

(52) U.S. Cl. CPC G06F 9/4887; G06N 3/063

(57) ABSTRACT

Embodiments relate to supporting context switching between tasks of multiple workloads by a system including a storage device, a processor, and a neural processing circuit with one or more neural engine circuits. A workload can include multiple tasks executed by the one or more neural engine circuits of the neural processing circuit. A scheduler can generate a number of slices of tasks for tasks of a first workload. The one or more neural engine circuits of the neural processing circuit can first execute a task of a second workload. Upon completion, the one or more neural engine circuits can perform context switching to switch to execute one or more tasks of a slice of the first workload.

### BACKGROUND

### Field of the Disclosure

The present disclosure relates to circuits and systems including neural processing circuits used in neural networks for supporting context switching between tasks of multiple workloads.

### Description of the Related Arts

An artificial neural network (ANN) is a computing system or model that uses a collection of connected nodes, such as neural processor circuits or neural processors, to process input data. An ANN can be organized into layers where different layers perform different types of transformation on their input data. Extensions or variants of ANN can include convolution neural networks (CNN), recurrent neural networks (RNN), deep belief networks (DBN), and other neural networks. These neural networks can involve extensive computing operations, including multiplication and accumulation. For example, CNN is a class of machine learning techniques that can use convolution between input data and kernel data, which can be decomposed into multiplication and accumulation operations.

Neural networks can be further applied in image data processing. Image data captured by an image sensor or received from other data sources can be processed in an image processing pipeline using various neural networks. Image processing operations can involve convolutions between input data and kernel data. Different kernels may be used to, for example, blur, sharpen, emboss or perform edge detect in the image based on various convolutions.

### SUMMARY

Embodiments relate to supporting context switching between tasks of multiple workloads by a system including a storage device, a processor, and a neural processing circuit including one or more neural engine circuits. A workload can include multiple tasks executed by the one or more neural engine circuits of the neural processing circuit. A scheduler can be operated by the processor to receive tasks of a first workload, and generate a first number of slices of tasks of the first workload. A slice of the first number of slices can include one or more tasks, where the first number is smaller than a predetermined maximum number of slices, and a duration of the slice representing a sum of durations for all tasks of the slice is smaller than a predetermined maximum duration. In addition, a first portion of the storage device can be used for executing the first number of slices of tasks by the one or more neural engine circuits, where the first portion of the storage device is smaller than a second portion of the storage device for executing a second number of slices of tasks of the first workload in response to the tasks of the first workload being divided into the second number of slices. The one or more neural engine circuits of the neural processing circuit can first execute a task of a second workload. Upon completion of the task of the second workload, the one or more neural engine circuits can perform context switching to switch to execute the one or more tasks of the slice of the first number of slices.

### BRIEF DESCRIPTION OF THE DRAWINGS

FIG. 1 is a high-level diagram of an electronic device, according to some embodiments.

FIG. 2 is a block diagram illustrating components in the electronic device, according to some embodiments.

FIG. 3A is a block diagram illustrating image processing pipelines, according to some embodiments.

FIG. 3B is a block diagram illustrating a neural processor circuit, according to some embodiments.

FIG. 4 is a block diagram illustrating a neural engine, according to some embodiments.

FIG. 5 is a conceptual diagram illustrating loops for processing input data at a neural processor circuit, according to some embodiments.

FIG. 6 is a conceptual diagram illustrating segmenting input data into slices, tiles, and work units, according to some embodiments.

FIG. 7 is a diagram illustrating programming of rasterizers in components of a neural processor circuit, according to some embodiments.

FIGS. 8A-8C are block diagrams illustrating a neural processor circuit supporting context switching between tasks of multiple workloads, according to some embodiments.

FIG. 9 is a flowchart illustrating a method for a neural processor circuit supporting context switching between tasks of multiple workloads, according to some embodiments.

FIG. 10 is an illustration of an example computer system for implementing some embodiments or portion(s) thereof of the disclosure provided herein, according to some embodiments.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural processor circuit for performing neural network operations, such as convolution operations. The neural processor circuit can include multiple neural engines (NEs), where each neural engine includes circuits or devices related to convolutions or other neural network operations. A neural processor circuit is also referred to herein as a “neural processor,” and a NE is also referred to herein as a “neural engine circuit.”

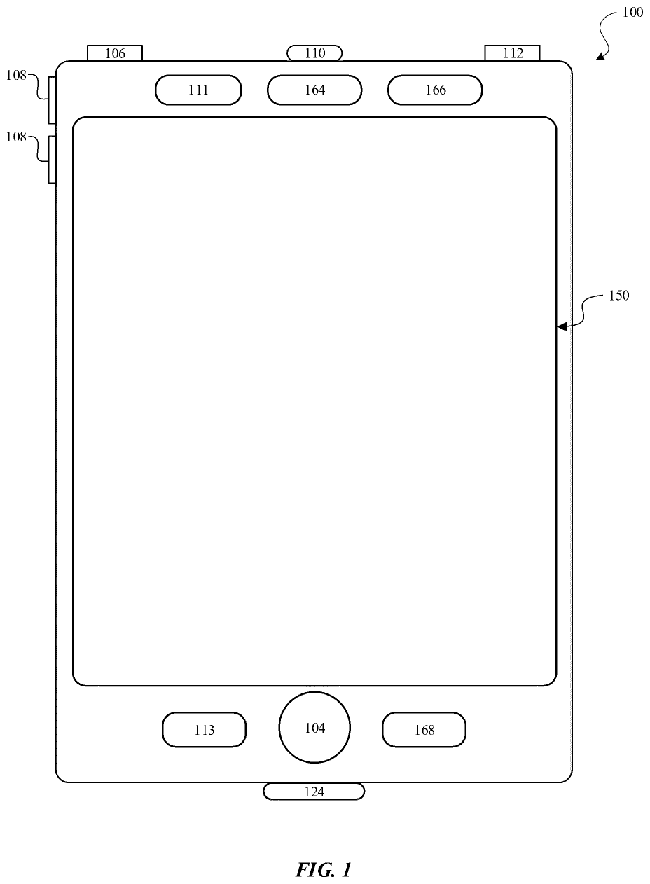

Embodiments of electronic devices, user interfaces for such devices, and associated processes for using such devices are described. In some embodiments, the device can be a portable communications device, such as a mobile telephone, that also includes other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include components not shown in FIG. 1.

Device 100 is an example of an electronic device and may have more or fewer components than listed above, some of which may be combined into components or have a different configuration or arrangement. The various components of device 100 listed above are embodied in hardware, software, firmware or a combination thereof, including one or more signal processing and/or application specific integrated circuits (ASICs).

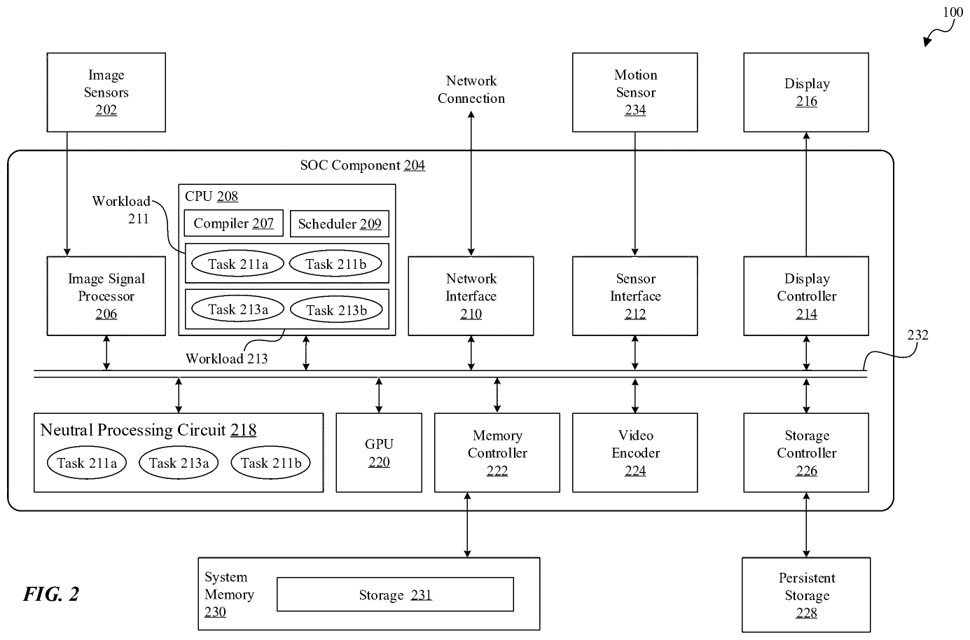

FIG. 2 is a block diagram illustrating components in device 100, according to some embodiments. Device 100 may perform various operations, including image processing. For this and other purposes, device 100 may include, among other components, image sensor 202, system-on-a chip (SOC) component 204, system memory 230, persistent storage (e.g., flash memory) 228, orientation sensor or motion sensor 234, and display 216. The components as illustrated in FIG. 2 are merely illustrative. For example, device 100 may include other components (e.g., speaker or microphone) that are not illustrated in FIG. 2. Further, some components (e.g., orientation sensor 234) may be omitted from device 100.

Image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230 or persistent storage 228, or sent to a remote computing device via network connection. The raw image data generated by image sensor 202 may be in a Bayer color kernel array (CFA) pattern (also referred to herein as “Bayer pattern”).

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 and rotating images displayed on display 216.

Display 216 is a component for displaying images generated by SOC component 204. Display 216 may include, for example, a liquid crystal display (LCD) device or an organic light emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory, or other non-volatile random access memory devices.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

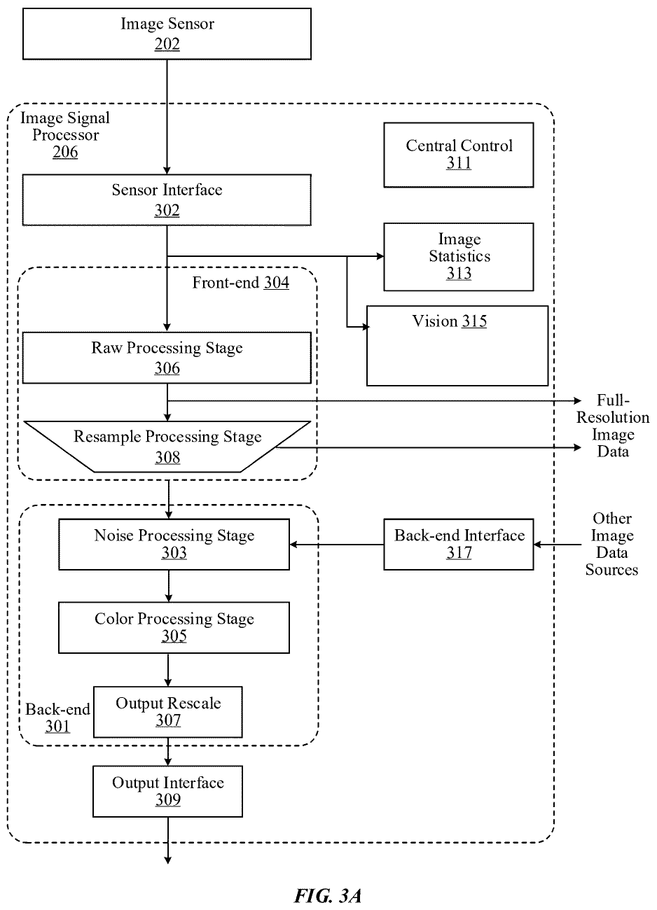

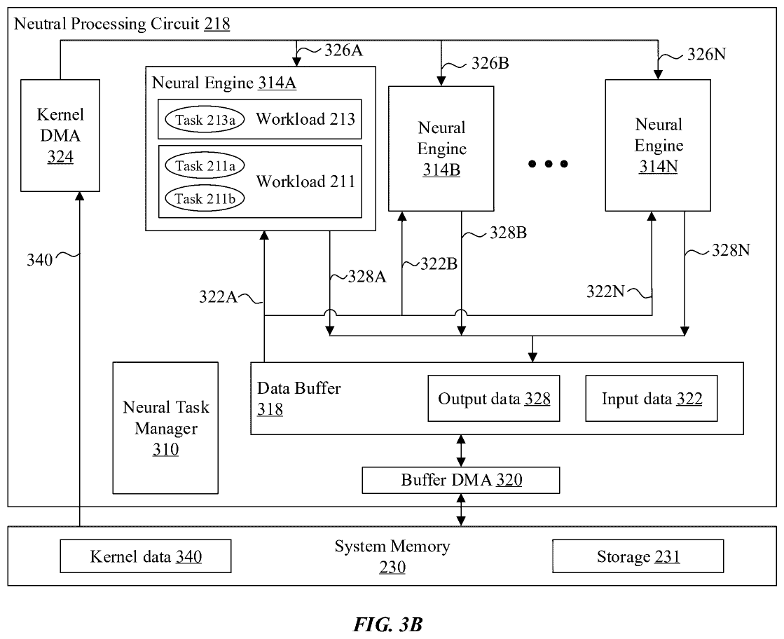

ISP 206 is hardware that performs various stages of an image processing pipeline. In some embodiments, ISP 206 may receive raw image data from image sensor 202 and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations, as described below with reference to FIG. 3A.

In some embodiments, ISP 206 can include a convolution engine that performs convolution operations (e.g., convolutions on raw image data from image sensor 202) and other processed data generated based on raw image data from image sensor 202. In some embodiments, the convolution engine can include components for storing convolution kernel data, for performing calculations (e.g., multiplication calculations), and for accumulating the multiplied values to generate an output. The convolution engine may perform various types of operations on the multi-channel image data, such as convolution operations, inter-channel processing operations, and per-channel processing operations. Example convolution operations may include generating edge maps or smoothed images. For example, an image convolved with a Gaussian kernel may produce a smooth image with reduced noise and aliasing. In another example, the convolution engine can generate image features, such as Gabor features for classification when an image is convolved with a set of multiple directional convolution kernels. Further, in some embodiments, the convolution engine can facilitate template matching for deep machine learning classification tasks, such as person or object detection. In some embodiments, convolutions for different purposes can have different kernel data.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may implement the same ISA. In some embodiments, CPU 208 can be configured to operate a compiler 207 and a scheduler 209. Compiler 207 can be operated by CPU 208 and generate tasks for a workload. In some embodiments, compiler 207 can generate the tasks, such as task 211a and task 211b, for a workload 211. Similarly, compiler 207 can generate tasks, such as task 213a and task 213b, for a workload 213. Task 211a, task 211b, task 213a, and task 213b are presented as examples. There can be other number of tasks for various workloads generated by compiler 207.

After compiler 207 generates the tasks for a workload, scheduler 209 can schedule the operations of the tasks. In some embodiments, the executions of the tasks can be performed by neural processor circuit 218, which can include one or more neural engine circuits. In some embodiments, scheduler 209 can schedule the execution of task 213a of workload 213 by neural processor circuit 218, followed by the execution of task 211a of workload 211 by neural processor circuit 218. The switching of execution for workload 213 to the execution for workload 211 by neural processor circuit 218 can be referred to as context switching for neural processor circuit 218. In some embodiments, neural processor circuit 218 can switch to execute multiple tasks of workload 211, such as the execution of task 211a and task 211b following the execution of task 213a of workload 213. Multiple tasks of a workload can form one or more slices of tasks. A portion of system memory 230 (e.g., storage 231) can be used to store data or intermediate computation results for context switching between different tasks of different slices of the workload.

Graphics processing unit (GPU) 220 is graphics processing circuitry for performing graphical data. For example, GPU 220 may render objects to be displayed into a frame buffer (e.g., a buffer that includes pixel data for an entire frame). GPU 220 may include one or more graphics processors that may execute graphics software to perform a part or all of the graphics operation or hardware acceleration of certain graphics operations.

Neural processor circuit 218 is a circuit that performs various machine learning operations based on computations that include multiplication, addition, and accumulation. Such computations may be arranged to perform, for example, convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 302, the image signal processor 206, system memory 230 or other sources (e.g., network interface 210 or GPU 220). The output of neural processor circuit 218 may be provided to various components of device 100 (e.g., image signal processor 206, system memory 230, or CPU 208) for various operations. The structure and operation of neural processor circuit 218 are described below with reference to FIG. 3B.

Network interface 210 is a subcomponent that enables data to be exchanged among device 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Storage controller 226 is circuitry for communicating with persistent storage 228. Storage controller 226 may read data from persistent storage 228 for processing by ISP 206, CPU 208, GPU 220, or other subcomponents of SOC component 204. Storage controller 226 may also write data to persistent storage 228 received from various subcomponents of SOC component 204.

Video encoder 224 is hardware, software, firmware, or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on ISP 206, CPU 208, or GPU 220. Such software components may be stored in system memory 230, persistent storage 228, or another device communicating with device 100 via network interface 210.

Image data or video data may flow through various data paths within SOC component 204. In one example, raw image data may be generated from image sensor 202 and processed by ISP 206, and then sent to system memory 230 via bus 232 and memory controller 222. After the image data is stored in system memory 230, it may be accessed by video encoder 224 for encoding or by display 116 for displaying via bus 232.

FIG. 3A is a block diagram illustrating image processing pipelines implemented using ISP 206, according to some embodiments. In some embodiments, ISP 206 is coupled to image sensor 202 to receive raw image data. ISP 206 implements an image processing pipeline which may include a set of stages that process image information from creation, capture, or receipt to output. ISP 206 may include, among other components, sensor interface 302, central control 311, front-end pipeline stages 304, back-end pipeline stages 301, image statistics device 313, vision device 315, back-end interface 317, and output interface 309. ISP 206 may include other components not illustrated in FIG. 3A or may omit one or more components illustrated in FIG. 3A.

In some embodiments, different components of ISP 206 process image data at different rates. In some embodiments, front-end pipeline stages 304 (e.g., raw processing stage 306 and resample processing stage 308) may process image data at an initial rate. Thus, the various different techniques, adjustments, modifications, or other processing operations are performed by these front-end pipeline stages 304 at the initial rate. For example, if the front-end pipeline stages 304 process 2 pixels per clock cycle, then raw processing stage 308 operations (e.g., black level compensation, highlight recovery, and defective pixel correction) may process 2 pixels of image data at a time. In contrast, one or more back-end pipeline stages 301 may process image data at a different rate less than the initial data rate. For example, back-end pipeline stages 301 (e.g., noise processing stage 303, color processing stage 305, and output rescale 307) may be processed at a reduced rate (e.g., 1 pixel per clock cycle). In some embodiments, back-end pipeline stages 301 may process image data at the initial data rate or at a different rate than the initial data rate.

Sensor interface 302 receives raw image data from image sensor 202 and processes the raw image data into image data processable by other stages in the pipeline. Sensor interface 302 may perform various preprocessing operations (e.g., image cropping, binning, and scaling) to reduce image data size. In some embodiments, pixels are sent from image sensor 202 to sensor interface 302 in raster order (e.g., horizontally, line by line). The subsequent processes in the pipeline may also be performed in raster order and the result may also be output in raster order. Although a single image sensor 202 and a single sensor interface 302 are illustrated in FIG. 3A, when more than one image sensor is provided in device 100, a corresponding number of sensor interfaces may be provided in ISP 206 to process raw image data from each image sensor.

Front-end pipeline stages 304 process image data in raw or full-color domains. Front-end pipeline stages 304 may include, but are not limited to, raw processing stage 306 and resample processing stage 308. A raw image data may be in Bayer raw image format, for example. In the Bayer raw image format, pixel data with values specific to a particular color (instead of all colors) is provided in each pixel. In an image capturing sensor, image data can be provided in a Bayer pattern. Raw processing stage 308 may process image data in the Bayer raw image format.

The operations performed by raw processing stage 306 include, but are not limited, sensor linearization, black level compensation, fixed pattern noise reduction, defective pixel correction, raw noise filtering, lens shading correction, white balance gain, and highlight recovery. Sensor linearization refers to mapping non-linear image data to linear space. Black level compensation refers to providing digital gain, offset, and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighbor pixels that are similar in brightness. Highlight recovery refers to estimating pixel values for clipped (or nearly clipped) pixels from other channels. Lens shading correction refers to applying a gain per pixel to compensate for a dropoff in intensity roughly proportional to a distance from a lens optical center. White balance gain refers to providing digital gains for white balance, offset, and clip independently for all color components (e.g., Gr, R, B, Gb). Components of ISP 206 may convert raw image data into image data in full-color domain, and thus, raw processing stage 308 may process image data in the full-color domain in addition to or instead of raw image data.

Resample processing stage 308 performs various operations to convert, resample, or scale image data received from raw processing stage 306. Operations performed by resample processing stage 308 may include, but not limited to, a demosaic operation, a per-pixel color correction operation, a Gamma mapping operation, a color space conversion, and a downscaling or sub-band splitting. The demosaic operation refers to converting or interpolating missing color samples from raw image data (e.g., in a Bayer pattern) to output image data into a full-color domain. The demosaic operation may include low pass directional filtering on the interpolated samples to obtain full-color pixels. The per-pixel color correction operation refers to a process of performing color correction on a per-pixel basis using information about relative noise standard deviations of each color channel to correct color without amplifying noise in the image data. The Gamma mapping operation refers to converting image data from input image data values to output data values to perform special image effects, including black and white conversion, sepia tone conversion, negative conversion, and solarize conversion. For the Gamma mapping operation, lookup tables (or other structures that index pixel values to another value) for different color components or channels of each pixel (e.g., a separate lookup table for Y, Cb, and Cr color components) may be used. The color space conversion operation refers to converting color space of an input image data into a different format. In some embodiments, resample processing stage 308 converts RBD format into YCbCr format for further processing.

Central control 311 may control and coordinate operations of other components in ISP 206. Central control 311 performs operations including, but not limited to, monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control 311 may update programmable parameters for other components in ISP 206 while the other components are in an idle state. After updating the programmable parameters, central control 311 may place these components of ISP 206 into a run state to perform one or more operations or tasks. Central control 311 may also instruct other components of ISP 206 to store image data (e.g., by writing to system memory 230 in FIG. 2) before, during, or after resample processing stage 308. In this way full-resolution image data in raw or full-color domain format may be stored in addition to or instead of processing the image data output from resample processing stage 308 through backend pipeline stages 301.

Image statistics device 313 performs various operations to collect statistic information associated with the image data. The operations for collecting statistics information may include, but not limited to, sensor linearization, mask patterned defective pixels, sub-sample raw image data, detect and replace non-patterned defective pixels, black level compensation, lens shading correction, and inverse black level compensation. After performing one or more of such operations, statistics information-such as 3A statistics (Auto white balance (AWB), auto exposure (AE), auto focus (AF)), histograms (e.g., 2D color or component), and any other image data information-may be collected or tracked. In some embodiments, certain pixel values or areas of pixel values may be excluded from collections of certain statistics data (e.g., AF statistics) when preceding operations identify clipped pixels. Although a single statistics device 313 is illustrated in FIG. 3A, multiple image statistics devices may be included in ISP 206. In some embodiments, each statistic device may be programmed by central control 311 to collect different information for the same or different image data.

Vision device 315 performs various operations to facilitate computer vision operations at CPU 208, such as facial detection in image data. Vision device 315 may perform various operations including pre-processing, global tone-mapping and Gamma correction, vision noise filtering, resizing, keypoint detection, convolution, and generation of histogram-of-orientation gradients (HOG). The pre-processing may include a subsampling or binning operation and computation of luminance if the input image data is not in YCrCb format. Global mapping and Gamma correction can be performed on the pre-processed data on a luminance image. Vision noise filtering is performed to remove pixel defects and reduce noise present in the image data to improve the quality and performance of subsequent computer vision algorithms. Such vision noise filtering may include detecting and fixing dots or defective pixels and performing bilateral filtering to reduce noise by averaging neighbor pixels of similar brightness. Various vision algorithms use images of different sizes and scales. Resizing of an image is performed, for example, by a binning or linear interpolation operation. Keypoints are locations within an image that are surrounded by image patches well suited to matching in other images of the same scene or object. Such keypoints are useful in image alignment, computing cameral pose, and object tracking. Keypoint detection refers to the process of identifying such keypoints in an image. Convolution may be used in image/video processing and machine vision. Convolution may be performed, for example, to generate edge maps of images or smoothen images. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations.

In some embodiments, a convolution engine can be implemented within vision device 315 or other components of ISP 206 to perform convolution operations on raw image data from image sensor 202 or other processed data generated based on raw image data from image sensor 202. In some embodiments, the convolution engine can include components for storing convolution kernel data, for performing calculations (e.g., multiplications), and for accumulating the multiplied values to generate an output. In some embodiments, operations of the convolution engine can be implemented by neutral processing circuit 218 individually or in coordination with ISP 206.

Back-end interface 317 receives image data from other image sources than image sensor 202 and forwards it to other components of ISP 206 for processing. For example, image data may be received over a network connection and be stored in system memory 230. Back-end interface 317 retrieves the image data stored in system memory 230 and provides it to back-end pipeline stages 301 for processing. Back-end interface 317 can convert the retrieved image data to a format that can be utilized by back-end processing stages 301. For instance, back-end interface 317 may convert RGB, YCbCr 4:2:0, or YCbCr 4:2:2 formatted image data into YCbCr 4:4:4 color formatted image data.

Back-end pipeline stages 301 processes image data according to a particular full-color format (e.g., YCbCr 4:4:4 or RGB). In some embodiments, components of back-end pipeline stages 301 may convert image data to a particular full-color format before further processing. Back-end pipeline stages 301 may include, among other stages, noise processing stage 303 and color processing stage 305. Back-end pipeline stages 301 may include other stages not illustrated in FIG. 3A.

Noise processing stage 303 performs operations to reduce noise in the image data. The operations performed by noise processing stage 303 include, but are not limited to, color space conversion, gamma/de-gamma mapping, temporal filtering, noise filtering, luma sharpening, and chroma noise reduction. The color space conversion operation may convert an image data from one color space format to another color space format (e.g., RGB format converted to YCbCr format). The gamma/de-gamma mapping operation converts image data from input image data values to output data values to perform special image effects. The temporal filtering operation filters noise using a previously-filtered image frame to reduce noise. For example, pixel values of a prior image frame are combined with pixel values of a current image frame. The noise filtering operation may include, for example, spatial noise filtering. The luma sharpening operation may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In some embodiments, spatial noise filtering may not be included as part of the temporal loop for temporal filtering (e.g., the spatial noise filter may be applied to an image frame after it is stored as a reference image frame (and thus is not a spatially filtered reference frame)).

Color processing stage 305 may perform various operations associated with adjusting color information in the image data. The operations performed in color processing stage 305 include, but are not limited to, local tone mapping, gain/offset/clip, color correction, three-dimensional color lookup, gamma conversion, and color space conversion. Local tone mapping refers to spatially varying local tone curves to provide more control when rendering an image. For instance, a two-dimensional grid of tone curves (which may be programmed by central control 311) may be bi-linearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to the image data. 3D color lookup may utilize a three dimensional array of color component output values (e.g., R, G, B) to perform advanced tone mapping, color space conversions, and other color transforms. Gamma conversion may be performed, for example, by mapping input image data values to output data values to perform gamma correction, tone mapping, or histogram matching. Color space conversion may be implemented to convert image data from one color space to another (e.g., RGB to YCbCr). Other processing techniques may also be performed as part of color processing stage 305 to perform other special image effects, including black and white conversion, sepia tone conversion, negative conversion, and solarize conversion.

Output rescale device 307 may resample, transform, and correct distortion on the fly as the ISP 206 processes image data. Output rescale device 307 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center to index an interpolated radial gain table, and applying a radial perturbance to a coordinate to account for a radial lens distortion).

Output rescale device 307 may apply transforms to image data as it is processed at output rescale device 307. Output rescale device 307 may include horizontal and vertical scaling components. The vertical portion of the design may implement a series of image data line buffers to hold the “support” needed by the vertical filter. As ISP 206 may be a streaming device, it may be that only the lines of the image data in a finite-length sliding window of lines are available for the filter to use. Once a line has been discarded to make room for a new incoming line, the line may be unavailable. Output rescale device 307 may statistically monitor computed input Y coordinates over previous lines and use it to compute an optimal set of lines to hold in the vertical support window. For each subsequent line, output rescale device 307 may automatically generate a guess as to the center of the vertical support window. In some embodiments, output rescale device 307 may implement a table of piecewise perspective transforms encoded as digital difference analyzer (DDA) steppers to perform a per-pixel perspective transformation between a input image data and output image data to correct artifacts and motion caused by sensor motion during the capture of the image frame. Output rescale may provide image data via output interface 307 to various other components of system 100, as discussed above with regard to FIGS. 1 and 2.

In some embodiments, the functionality of components 301 through 317 may be performed in a different order than the order implied by the order of these functional units in the image processing pipeline illustrated in FIG. 3A, or may be performed by different functional components than those illustrated in FIG. 3A. Moreover, the various components as described in FIG. 3A may be embodied in various combinations of hardware, firmware, or software.

FIG. 3B illustrates neural processor circuit 218, according to some embodiments. Neural processor circuit 218 is a configurable circuit that performs neural network operations on input data 322 stored in data buffer 318 based at least on kernel data 340 stored in system memory 230. In some embodiments, neural processor circuit 218 may include, among other components, neural task manager 310, neural engines 314A through 314N (collectively referred to herein as “neural engines 314” and individually referred to herein as “neural engine 314”), kernel direct memory access (DMA) 324, data buffer 318, and buffer DMA 320. Neural processor circuit 218 may include other components not illustrated in FIG. 3B.

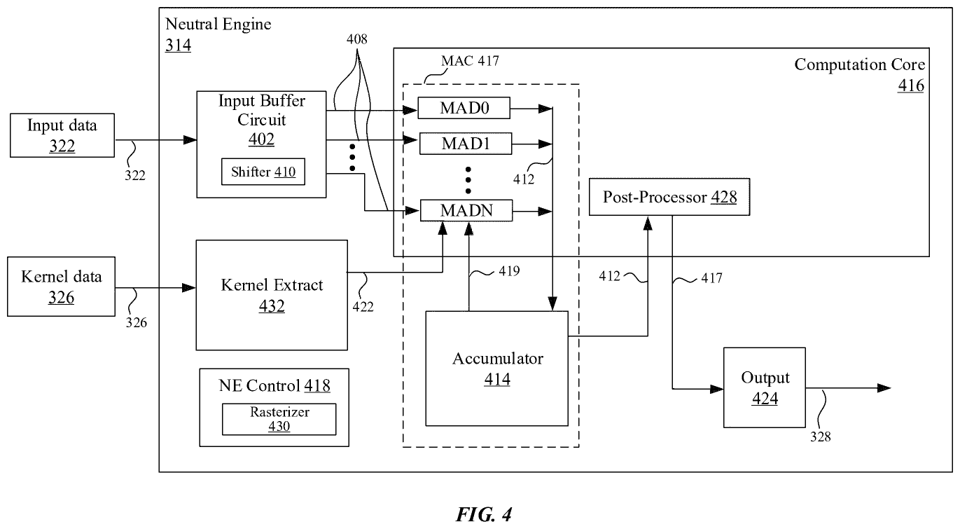

Each of neural engines 314 performs computing operations for neural network operations in parallel, according to some embodiments. Depending on the load of an operation, an entire set of neural engines 314 may be operated or a subset of neural engines 314 may be operated while the remaining neural engines 314 are placed in a power save mode. Each of neural engines 314 includes components for storing one or more kernels, for performing multiply-accumulate operations, and for post processing to generate an output data 328, as described below with reference to FIG. 4. One example of a neural network operation is a convolution operation.

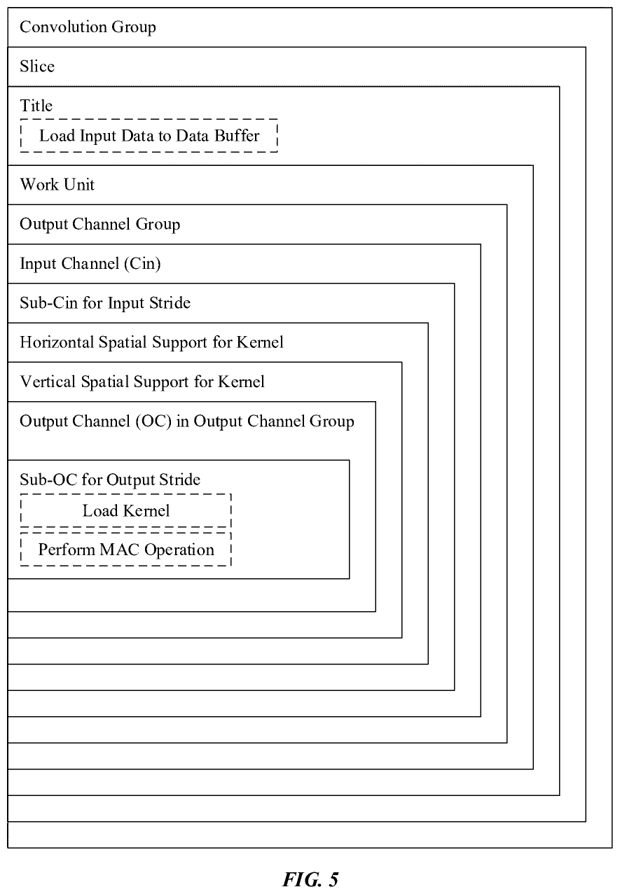

Neural task manager 310 manages the overall operation of neural processor circuit 218. Neural task manager 310 may receive a task list from a compiler executed by CPU 208, such as the task list for workload 211 or workload 213, store tasks in its task queues, choose a task to perform, and send instructions to other components of neural processor circuit 218 for performing the chosen task. Neural task manager 310 may also perform switching of tasks on detection of events, such as receiving instructions from CPU 208. In some embodiments, neural task manager 310 can receive instructions from scheduler 209 and schedule the execution of task 213a of workload 213 by neural engine 314A, followed by the execution of task 211a and task 211b of workload 211 by neural engine 314A. In some embodiments, there can be multiple neural engine circuits (e.g., neural engine 314A and neural engine 314B) for executing task 213a, task 211a, and task 211b. In some embodiments, neural task manager 310 sends rasterizer information to the components of neural processor circuit 218 to enable each of the components to track, retrieve, or process appropriate portions of the input data and kernel data, as described below with reference to FIGS. 5-7. Although neural task manager 310 is illustrated in FIG. 3B as part of neural processor circuit 218, neural task manager 310 may be a component outside of neural processor circuit 218.

Kernel DMA 324 is a read circuit that fetches kernel data 340 from a source (e.g., system memory 230) and sends kernel data 326A through 326N to each of neural engines 314, where kernel data 326A through 326N can be the same or a processed version of kernel data 340. The kernel data represents information from which kernel elements or parameters can be extracted. In some embodiments, the kernel data may be in a compressed format that is decompressed at each of neural engines 314. Although kernel data provided to each of neural engines 314 may be the same in some instances, the kernel data provided to each of neural engines 314 is different in most instances, according to some embodiments.

Data buffer 318 is a temporary storage for storing data associated with the neural network operations. In some embodiments, data buffer 318 is embodied as a memory that can be accessed and shared by all of neural engines 314 including neural engines 314A through 314N. Data buffer 318 may store input data 322A through 322N for feeding to corresponding neural engines 314A through 314N, as well as output from each of neural engines 314A through 314N for feeding back into neural engines 314 or sending to a target circuit (e.g., system memory 230). Input data 322A through 322N can be a part or all of input data 322 stored in data buffer 318. The operations of data buffer 318 and other components of neural processor circuit 218 are coordinated so that the input data and intermediate data stored in data buffer 318 are reused across multiple operations at neural engines 314 to reduce data transfer to and from system memory 230. Data buffer 318 may be operated in a broadcast mode, where data input data of all input channels are fed to all neural engines 314 or in a unicast mode where data input data of a subset of input channels are fed to each neural engine 314, according to some embodiments.

In some embodiments, input data 322 stored in data buffer 318 may be part of, among others, image data, HOG data, audio data, meta data, output data 328 of a previous cycle of neural engine 314, and other processed data received from other components of SOC component 204. In some embodiments, input data 322 includes pixel values of an image. In some embodiments, input data 322 can be other types of data (e.g., HOG data) suitable for a convolution operation. In some embodiments, input data 322 can include a stream of input values or a stream of values, such as a sequence, a group, a set, an array, and an ordered list of numbers, where each element or parameter of the array or the ordered list includes a number representing a value for a pixel of an image. A basic unit of input data 322 can be referred to as an “input element” or an “input parameter,” which can be a number representing a value for a pixel of an image.

In some embodiments, neural engine 314A can include components for a convolution engine (e.g., an input transformer, a kernel transformer, an output transformer), which can perform operations for convolutions (e.g., convolutions based on a Winograd transform). In some embodiments, the input transformer can be an input transformation circuit to perform input transformation operations. Similarly, the kernel transformer can be a kernel transformation circuit to perform kernel transformation; while the output transformer can be an output transformation circuit to perform output transformation.

In addition, neural engine 314A can include a number of adders. In some embodiments, neural engine 314A can perform operations for numbers in different representations. For example, input data 322 can include parameters that are numbers represented by 8-bit signed or unsigned numbers, 16-bit floating point numbers, or other number representations.

In some embodiments, neural engine 314B through neural engine 314N can have a similar structure or implementation as neural engine 314A. In some embodiments, neural engine 314B through neural engine 314N can have more components or fewer components than those shown for neural engine 314A.

Buffer DMA 320 includes a read circuit that receives a portion (e.g., tile) of the input data from a source (e.g., system memory 230) for storing in data buffer 318 and includes a write circuit that forwards data from data buffer 138 to a target (e.g., system memory).

FIG. 4 is a block diagram of neural engine (NE) 314, according to some embodiments. In some embodiments, neural engine 314 can be an example of neural engine 314A, 314B, . . . , or 314N. Neural engine 314 performs various operations to facilitate neural network operations, such as convolution, spatial pooling, and local response normalization. Neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or multiple channels.

Neural engine 314 may include, among other components, input buffer circuit 402, computation core 416, neural engine control 418, kernel extract circuit 432, accumulators 414, and output circuit 424. Neural engine 314 may include further components not illustrated in FIG. 4.

Input buffer circuit 402 is a circuit that stores a portion of input data 322 as it is received from data buffer 318 and sends an appropriate portion 408 of input data for a current task or process loop to computation core 416 for processing. Input buffer circuit 402 includes a shifter 410 that shifts read locations of input buffer circuit 402 to change portion 408 of input data sent to computation core 416. By changing portions of input data provided to computation core 416 via shifting, neural engine 314 can perform multiply-accumulate for different portions of input data based on fewer number of read operations. In some embodiments, the input data 322 includes data of different convolution groups and/or input channels.

Kernel extract circuit 432 is a circuit that receives kernel data 326 from kernel DMA 324 and extracts kernel coefficients 422, which can also be referred to as “kernel parameters.” In some embodiments, kernel extract circuit 432 references a look-up table (LUT) and uses a mask to reconstruct a kernel from compressed kernel data 326. The mask indicates locations in the reconstructed kernel to be padded with zero and remaining locations to be filled with numbers. Kernel coefficients 422 of the reconstructed kernel are sent to computation core 416 to populate a register in multiply-add (MAD) circuits of computation core 416. In some embodiments, kernel extract circuit 432 receives kernel data in an uncompressed format and the kernel coefficients are determined without referencing a LUT or using a mask.

Computation core 416 is a programmable circuit that performs computation operations. In some embodiments, computation core 416 may include MAD circuits MADO through MADN and a post processor 428. Each of the MAD circuits MADO through MADN may receive an input value in portion 408 of the input data and a corresponding kernel coefficient in kernel coefficients 422. The input value and the corresponding kernel coefficient are multiplied in each of the MAD circuits to generate a processed value 412.

Accumulator 414 is a memory circuit that receives and stores processed values 412 from the MAD circuits. The processed values stored in accumulator 414 may be sent back as feedback information 419 for further multiply and add operations at the MAD circuits or sent to post processor 428 for post processing. Accumulator 414 in combination with the MAD circuits form a multiply-accumulator (MAC) 404. In some embodiments, accumulator 414 may have subunits, where each subunit sends data to different components of neural engine 314. For example, during a processing cycle, data stored in a first subunit of accumulator 414 is sent to MAC circuits, while data stored in a second subunit of accumulator 414 is sent to post processor 428.

Post processor 428 is a circuit that performs further processing of values 412 received from accumulator 414. Post processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is an output from post processor 428 as processed values 417 to output circuit 424.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAD circuits, and perform different types of post-processing operations at post processor 428. To configure components of neural engine 314 to operate in a desired manner, NE control 418 sends control signal to components of the neural engine. NE control 418 may also include rasterizer 430 that tracks the current task or process loop being processed at neural engine 314, as described below with reference to FIGS. 5-7.

Output circuit 424 receives processed values 417 from post processor 428 and interfaces with data buffer 318 to store processed values 417 in data buffer 318. In some embodiments, output circuit 424 may send output data 328 in a sequence or a format that is different from the sequence or format in which processed values 417 are processed in post processor 428.

The components in neural engine 314 may be configured during a configuration period by NE control 418 and neural task manager 310. In some embodiments, neural task manager 310 sends configuration information to neural engine 314 during a configuration period. The configurable parameters and modes may include, but are not limited to, mapping between input data parameters or elements and kernel parameters or elements, the number of input channels, the number of output channels, performing of output strides, and enabling/selection of post-processing operations at post processor 428.

FIG. 5 is a conceptual diagram illustrating loops for processing the input data at neural processor circuit 218, according to some embodiments. The outermost loop represents processing for a convolution group, if group convolution involving multiple convolution groups is used. Group convolutions are convolutions where input data of the input channels in each group are used only for generating output data of output channels of each group but are not used for generating output data for output channels of other groups, according to some embodiments. Hence, each group of the group convolution can be treated as a separate convolution operation.

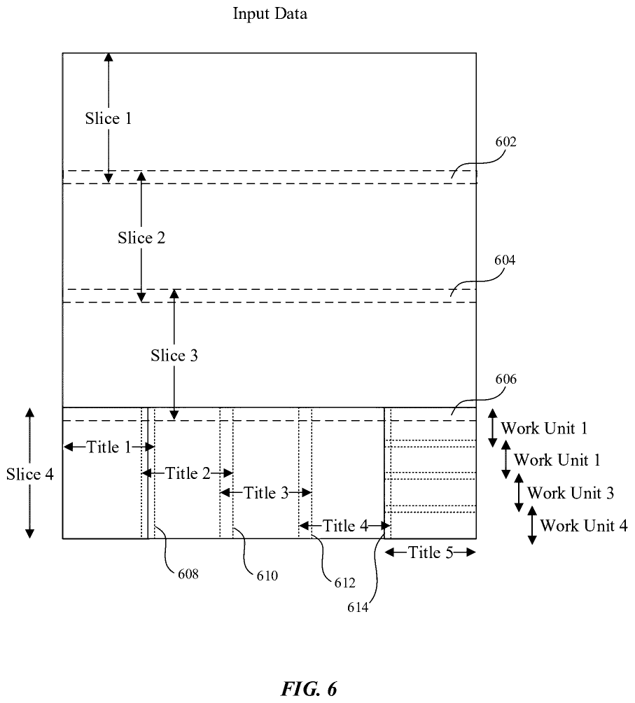

A processing loop for a slice of the input data is in the loop for each convolution group. The entire input data for a convolution operation is segmented into multiple strips of slices in an overlapping manner, as shown in FIG. 6. Overlapping portions 602, 604, and 606 are parts of the input data that are over fetched in two adjacent slices to provide spatial support for a corresponding kernel. The second outermost loop performs a convolution operation for each slice in the input data. Within the loop for a slice is a processing loop for a tile of the slice. Each slice is segmented into tiles, as shown in FIG. 6. Overlapping portions 608, 610, 612, and 614 are parts of the input data in slice 4 that are over fetched in two adjacent tiles to provide spatial support for a corresponding kernel. The rightmost tile can have a width smaller than other tiles of the slice. In some embodiments, input data for each tile is loaded onto data buffer 318 in a read cycle and reused for operations in processing loops for the tile. A processing loop for a work unit is in the processing loop for the tile. Each tile is segmented into multiple work units as shown in FIG. 6. A work unit is a portion of the input data having a size that produces output values that fit into accumulator 414 of neural engine 314 during a single cycle of computation core 416. Although the shape of each work unit is shown as a horizontal strip in FIG. 6, the shape of the work unit can be different depending on the shape and size of the tile. The work units also have overlapping parts that represent overfetched data to provide support for a corresponding kernel. Work units for the last tile of a slice may have a shape of a vertical strip if the tile is tall. In some embodiments, the size of each work unit is 256 bytes. For example, work units can be shaped to one of 16×16, 32×8, 64×4, 128×2, or 256×1 dimension.

For each work unit, an internal processing loop may be provided for an output channel group (OCG). The number of output channels produced for a given work unit by a single cycle of computation core 416 is referred to as an “OCG.” Depending on operation modes, each neural engine 314 may process output data of different numbers of output channels (e.g., 8 channels, 32 channels) for a single load of input data into its input buffer circuit 402.

For each output channel group, an internal processing loop may be provided for an input channel (Cin). If an input stride is implemented to skip certain input data, loops for sub-input channels (Sub-Cin) may be provided within the processing loop for the input channel (Cin).

For each input channel or each sub-input channel, internal loops are provided for processing horizontal spatial support for a kernel and the vertical support within each horizontal spatial support. The spatial support refers to the input data for convolution with the kernel and includes overfetched input data for performing convolution at the edges of the input data.

Overfetch refers to fetching additional input data in a current slice, tile, or work unit so that a proper dimension of input data can be provided for convolution with a kernel. In some embodiments, overfetch is performed vertically between slices to obtain additional rows of input data (shown as overlapping portions 602, 604, and 606 in FIG. 6), horizontally between tiles to obtain additional columns of input data (shown as overlapping portions 608, 606, 612, and 614 in FIG. 6), and vertically between work units within a tile to obtain additional rows of input data.

For each spatial support for the kernel, an internal processing loop for an output channel (OC) is provided to generate output data for each output channel (Cout). In cases where an output stride implements a spatial upsampling, an additional inner loop for processing each sub-output channel is provided. Loading of kernel coefficients and MAC operations are performed within the loop for the output channel (OC) or sub-output channel if an output stride is implemented, to generate output data for the output channel (OC) or sub-output channel.

The nested loop structure of FIG. 5 is merely illustrative. Loops may be omitted, added or structured differently depending on various factors. For example, if only a single convolution group is used, the outermost loop may be removed. Further, the loop structure for the horizontal spatial support and the vertical spatial support may be reversed.

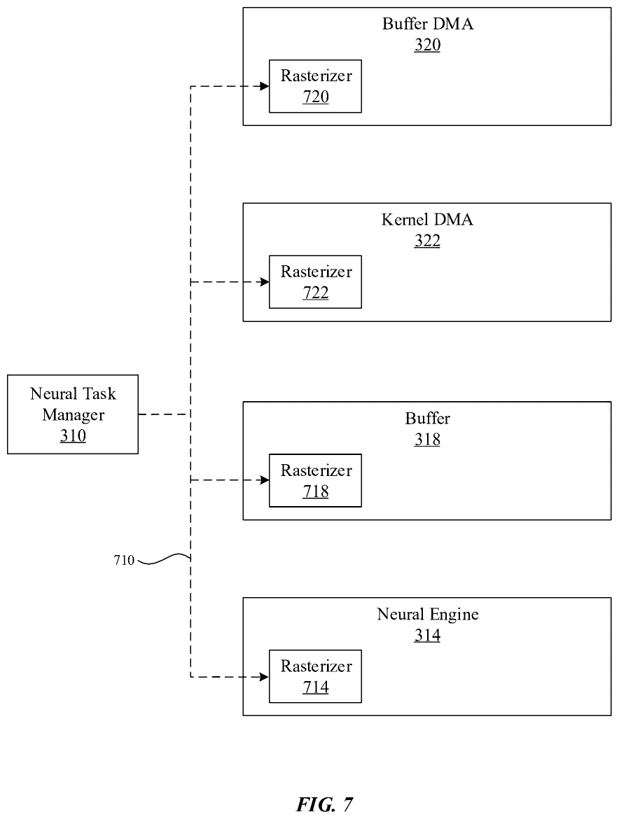

In some embodiments, the operations associated dividing the input space into smaller units and processing these smaller units as described above with reference to FIGS. 5 and 6 are performed by rasterizers 714, 718, 720, and 722 of FIG. 7 in various components of neural processor circuit 218. A rasterizer is a circuit of neural processor circuit 218 that keeps track of the segment of the input/output data (e.g., group, work unit, input channel, and output channel) and instructs the components of neural processor circuit 218 for proper handling of the segment of the input data. For example, rasterizer 720 in buffer DMA 320 tracks tiles and slices received from system memory 230, while rasterizer 718 in data buffer 318 broadcasts in sequence work units for processing by neural engines 314. Rasterizer 724 in kernel DMA 324 determines which kernels are to be received and distributed to neural engines 314, while rasterizers 714 in neural engines 314 operate shifters 410 in input buffer circuits 402 to forward correct portions 408 of input data to MAC 404 and send the finished output data 328 to data buffer 318.

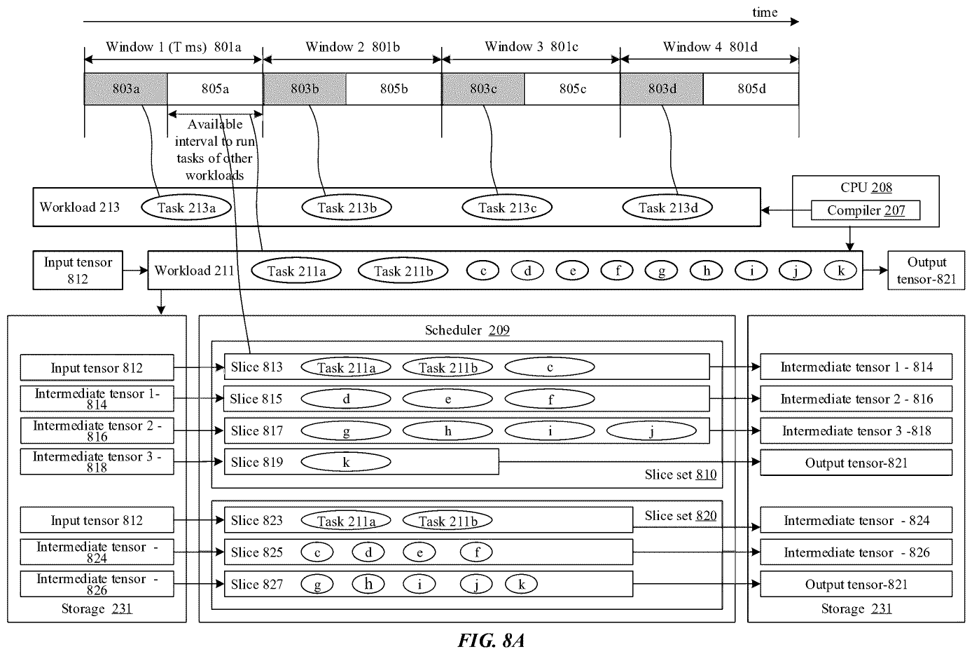

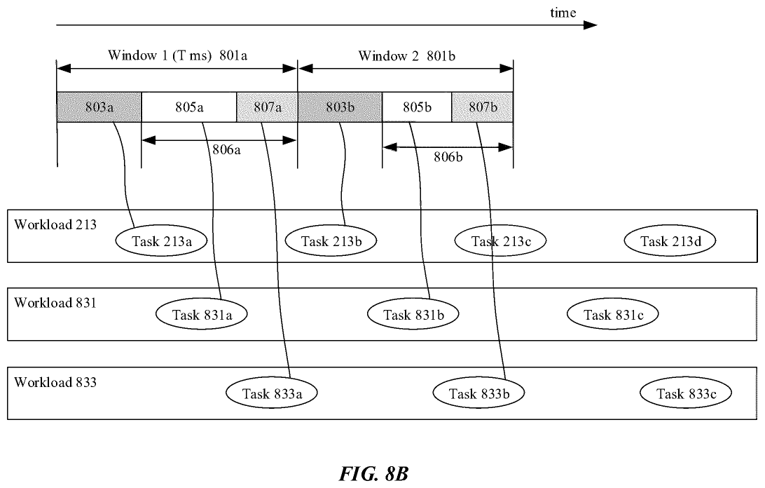

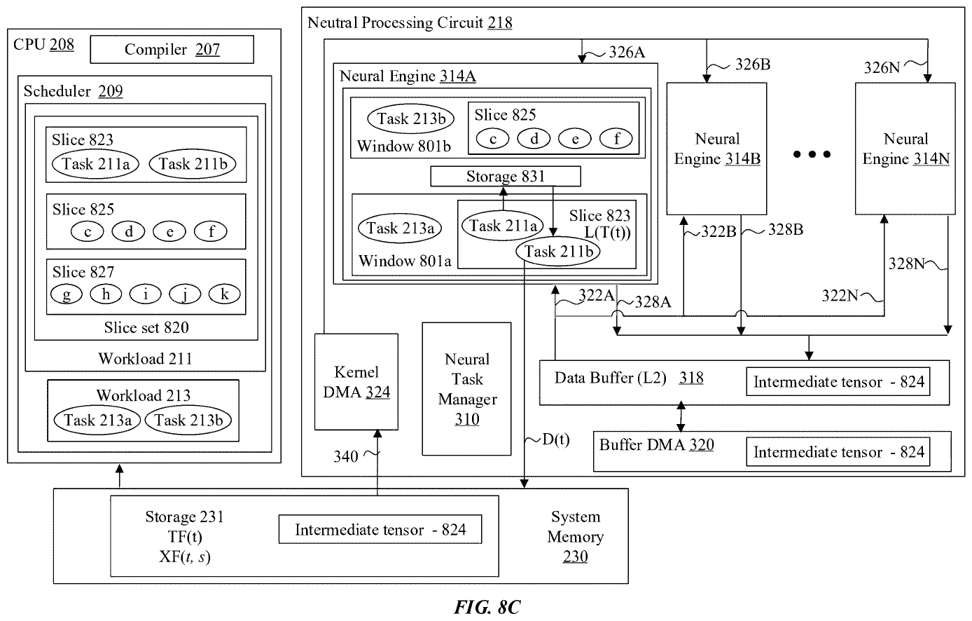

FIGS. 8A-8C are block diagrams illustrating a neural processor circuit supporting context switching between tasks of multiple workloads, according to some embodiments. In some embodiments, operations and systems illustrated in FIGS. 8A-8C are based on CPU 208 and neural processor circuit 218 of device 100, as shown in FIG. 2, 3A, and 3B.

In some embodiments, a workload can take an input tensor and generate an output tensor. For example, workload 211 can receive an input tensor 812 and generate an output tensor 821. A workload can perform the operations to generate output tensor 821 by a sequence of tasks, where input tensor 812 and output tensor 821 can be stored in storage device 231 within system memory 230. In some embodiments, compiler 207 can be operated by CPU 208 to generate a list of tasks for a workload. In some embodiments, compiler 207 can generate a list of tasks (e.g., task 213a-213d) for workload 213 and generate a list of tasks (e.g., task 211a-task 211k) for workload 211. In some embodiments, task 211a-task 211k are illustrated as (task 211a, task 211b, 211c, 211d, 211e, 211f, 211g, 211h, 211i, 211j, 211k) in FIGS. 8A and 8C due to space limit. Accordingly, task 211c is shown as task c in FIGS. 8A and 8C, which can be described as either task 211c or task c in the current description. Other tasks of workload 211 can be described in a similar way. In some embodiments, workload 211 can have a first priority and workload 213 can have a second priority higher than the first priority. Accordingly, a task for workload 213 can have the second priority, and a task for workload 211 can have the first priority lower than the second priority.

In some embodiments, a task for workload 213 can be executed within a periodic execution window. In some embodiments, task 213a can be executed within window 801a, which can last T milliseconds (ms). Similarly, task 213b can be executed within window 801b of T ms, task 213c can be executed within window 801c of T ms, and task 213d can be executed within window 801d of T ms. Window 801a, window 801b, window 801c, and window 801d can have an equal length of T ms, which form a sequence of periodic execution windows for tasks of workload 213.

In some embodiments, a task of workload 213 may not fully occupy the entire length of an execution window. In some embodiments, task 213a can be executed at an interval 803a within window 801a, where interval 803a occupies a beginning part of window 801a. Accordingly, the remaining part of window 801a that is not used for executing task 213a can be referred to as an inactive interval that can be used to execute tasks of another workload of a lower priority. In some embodiments, interval 803a of window 801a can be used to execute task 213a of workload 213, and interval 805a of window 801a can be used to execute task 211a of workload 211 that has lower priority than workload 213, where interval 805a is the remaining part of window 801. In some embodiments, one or more neural engine circuits 314A, 314B, . . . 314N of neural processing circuit 218 can execute task 213a of workload 213. Upon completion of the execution of task 213a, one or more neural engine circuits 314A, 314B, . . . 314N of neural processing circuit 218 can switch to execute the one or more tasks of workload 211 (e.g., task 211a).

In some embodiments, similarly, interval 803b of window 801b can be used to execute task 213b of workload 213, and interval 805b of window 801b can be used to execute one or more tasks of workload 211 (e.g., task 211c or task 211d) that has lower priority than workload 213. In addition, interval 803c of window 801c can be used to execute task 213c of workload 213, and interval 805c of window 801c can be used to execute one or more tasks of workload 211. Furthermore, interval 803d of window 801d can be used to execute task 213d of workload 213, and interval 805d of window 801d can be used to execute one or more tasks of workload 211.

In some embodiments, a periodic execution window, which can be referred to as an “execution window” or a “window,” can be assigned to execute a task of workload 213 in addition to one or more tasks of workload 211, where the one or more tasks can form a slice of tasks of workload 211. In some embodiments, the execution window can be assigned to execute a task of workload 213 in addition to one or more tasks of multiple workloads, such as workload 211 and one or more additional workloads.

In some embodiments, there can be more than two workloads that can be executed in a pipelined manner as shown FIG. 8B. In some embodiments, task 213a can be executed at interval 803a within window 801a, interval 805a of window 801a can be used to execute task 831a of workload 831, and interval 807a of window 801a can be used to execute task 833a of workload 833. Interval 805a and interval 807a can form an inactive window 806a for window 801a that is not used to execute a task for workload 213. Similarly, task 213b can be executed at interval 803b within window 801b, interval 805b of window 801b can be used to execute task 831b of workload 831, and interval 807b of window 801b can be used to execute task 833b of workload 833. Interval 805b and interval 807b can form an inactive window 806b for window 801b that is not used to execute a task for workload 213. In some embodiments, workload 213 can have a priority that is higher than a priority of workload 831 or workload 833. In some embodiments, workload 831 and workload 833 can have the same priority or different priorities.

In some embodiments, scheduler 209 can be configured to receive the tasks of workload 211 generated by compiler 207 and to generate a slice set having a number of slices of tasks for the tasks of workload 211, where a slice of tasks can include one or more tasks. In some embodiments, the tasks of a workload can include an ordered list of tasks (T(1), . . . T(t), . . . , T(n)), where a task T(t) of the ordered list of tasks has an associated task rank t in an increasing order defined by natural numbers {1, . . . , t, . . . , n}. The task T(t) can be executed by one or more neural engine circuits (e.g., NE 314A) of neural processing circuit 218 with a duration or latency L(T(t)). In some embodiments, a duration and a latency can be used interchangeably.

In some embodiments, for workload 211, scheduler 209 can generate a slice set 810 including a slice 813 having tasks 211a, 211b, and 211c, a slice 815 having tasks 211d, 211e, 211f, a slice 817 having tasks 211g, 211h, 211i, 211j, and a slice 819 having task 211k. Additionally and alternatively, scheduler 209 can generate a slice set 820 including a slice 823 having tasks 211a, 211b, a slice 825 having tasks 211c, 211d, 211e, 211f, and a slice 827 having tasks 211g, 211h, 211i, 211j, 211k. There can be many ways to break the list of tasks (211a, 211b, 211c, 211d, 211e, 211f, 211g, 211h, 211i, 211j, 211k) for workload 211 into various slices, where slice set 810 and slice set 820 are two examples. In some embodiments, a slice set, such as slice set 810 and slice set 820, can be defined implicitly by scheduler 209.

In some embodiments, the one or more tasks of a slice of workload 211 can be executed within a periodic execution window for workload 213 by one or more neural engine circuits (e.g., NE 314A) of neural processing circuit 218. In some embodiments, input tensor 812 of workload 211 can be provided to tasks of slice 813. Afterwards, tasks of slice 813 can be executed by one or more neural engine circuits (e.g., NE 314A) to generate an intermediate tensor 814, which can be stored in storage 231 of system memory 230 external to neural processing circuit 218. Data of intermediate tensor 814 can be provided as an input for the execution of tasks of slice 815, which can further generate an intermediate tensor 816 to be saved in storage 231. Similarly, data of intermediate tensor 816 can be provided as an input for the execution of tasks of slice 817, which can further generate an intermediate tensor 818 to be saved in storage 231. Finally, data of intermediate tensor 818 can be provided as an input for the execution of tasks of slice 819, which can further generate output tensor 821 for workload 211. In some embodiments, intermediate tensors can be stored within data buffer 318, buffer DMA 320, and/or storage 231, depending on various implementation techniques. In some embodiments, storage 231 of system memory 230 can be used as an example for storing the intermediate tensors. In some embodiments, intermediate tensors can be stored only in data buffer 318 and buffer DMA 320 without being stored in storage 231.

In some embodiments, intermediate tensor 814, intermediate tensor 816, and intermediate tensor 818 can take up storage space in storage 231 of system memory 230. In addition, it can take time to send intermediate tensor 814, intermediate tensor 816, and intermediate tensor 818 generated by the one or more neural engine circuits to storage 231 of system memory 230. In some embodiments, scheduler 209 can consider multiple ways to break the list of tasks (task 211a, 211b, 211c, 211d, 211e, 211f, 211g, 211h, 211i, 211j, 211k) for workload 211 into different number of slices and different slices to determine an optimized slice set for execution of workload 211 within execution windows of workload 213 to use smaller storage 231 of system memory 230 and to reduce the time to move intermediate tensors from the one or more neural engine circuits to storage 231 of system memory 230.

In some embodiments, as an alternative and in a similar fashion, input tensor 812 of workload 211 can be provided to tasks of slice 823. Afterwards, tasks of slice 823 can be executed by one or more neural engine circuits (e.g., NE 314A) to generate an intermediate tensor 824, which can be stored in storage 231 of system memory 230 external to neural processing circuit 218. Data of intermediate tensor 824 can be provided as an input for the execution of tasks of slice 825, which can further generate an intermediate tensor 826 to be saved in storage 231. Similarly, data of intermediate tensor 826 can be provided as an input for the execution of tasks of slice 827, which can further generate output tensor 821 for workload 211. During the scheduling process, scheduler 209 can consider both slice set 810 and slice set 820 to execute workload 211. Scheduler 209 may select slice set 810 or slice set 820 to be sent to one or more neural engines (e.g., NE 314A) of neural processing circuit 218 for execution of workload 211.

In some embodiments, the execution of tasks of slices in slice set 820 is illustrated in FIG. 8C. During window 801a, task 213a of workload 213 is first executed by NE 314A, together with task 211a and task 211b of slice 823 of workload 211. The execution of each task T(t) can have a latency L(T(t)), where T(t) represents a task such as task 211a and task 211b. Hence, task 211a can have a latency L (task 211a), and task 211b can have a latency L (task 211b). NE 314A can execute task 211a before executing task 211b. An output generated by executing task 211a of slice 823 can be stored by an internal storage device 831 of NE 314A. NE 314A can further execute task 211b having latency L (task 211b) and generate an output that can be intermediate tensor 824. NE 314A can further move intermediate tensor 824 into storage 231, where the movement of intermediate tensor 824 can take up D (task 211b) time. In some embodiments, for a task T(t), the time to move an intermediate tensor computed at task T(t) can take up D(t) time. In addition, intermediate tensor 824 can take up TF (task 211b) storage space in storage 231. In some embodiments, for a task T(t), a space used to store intermediate tensor 824 after computing task T(t) can be denoted as TF(t).

In some embodiments, an output generated by executing a slice of workload 211 can be stored in storage 231 external to neural processing circuit 218. In addition, the output generated by executing the slice can be provided as an input for executing a next slice of workload 211. In some embodiments, intermediate tensor 824 can be provided as input for computing tasks of slice 825 for workload 211 within window 801b.

In some embodiments, the execution of workload 211 is scheduled to be performed one slice at a time within an execution window for workload 213. Scheduler 209 can perform operations to estimate the cost for performing such executions of tasks of the slices, and further find an optimal way to divide the list of tasks (T(1), . . . T(t), . . . , T(n)) for workload 211 into a number of slices. The execution of each task T(t) can have a latency L(T(t)). In some embodiments, the list of tasks (T(1), . . . T(t), . . . , T(n)) for workload 211 can be divided into an ordered list of slices (S(1), . . . S(s), . . . , S(m)), a slice S(s) of the ordered list of slices having an associated slice rank s in the increasing order defined by natural numbers. A previous slice S(s−1) includes a set of tasks (T(t1), . . . , T(t2)), and a current slice S(s) includes a set of tasks (T(t2+1), . . . , T(t3)), where t1, t2, and t3 are natural numbers satisfying t1≤t2<t3. In some embodiments, S(s) can have an execution time defined by the sum of the one or more tasks of slice S(s)={T(t2+1), . . . , T(t3)}, which is L(S(s))=L(T(t2+1))+ . . . +L(T(t3)). In some embodiments, an amount of external memory TF(t) can be allocated for executing task T(t), and an amount of external memory XF(t, s) can be allocated for executing the slice S(s) including the task T(t).

In some embodiments, when slice S(s) is scheduled to be executed with a task of workload 213, the execution time of the task of workload 213 and the latency of L(S(s)) of slice S(s) can be smaller than or equal to a length of the periodic execution window for workload 213.

In some embodiments, when one or more tasks of a slice of workload 211 can be executed within a periodic execution window for workload 213, one slice of workload 211 is executed within one periodic execution window for workload 213. In some embodiments, scheduler 209 can generate slice set 820 including slice 823 having tasks as (task 211a, task 211b), slice 825 having tasks as (211c, 211d, 211e, 211f), and a slice 827 having tasks as (211g, 211h, 211i, 211j, 211k). Slice 823 is scheduled to be executed within window 801a after the execution of task 213a. Accordingly, L(task 213a)+L(task 211a)+L(task 211b) is less than or equal to T, the length of window 801a. Similarly, slice 825 is scheduled to be executed within window 801b after the execution of task 213b. Accordingly, L(task 213b)+L(task (211c))+L(task (211d))+L(task (211e))+L(task (211f)) is less than or equal to T, the length of window 801b.

In some embodiments, there can be an another workload in addition to workload 211 and workload 213, where the other workload can have a priority lower than the priority of workload 213. NE 314A of neural processing circuit 218 can execute one or more tasks of a slice of the other workload for an execution time after executing the one or more tasks of the slice of workload 211. Accordingly, a sum of the execution time for a slice of workload 211, the execution time of a task of workload 213, and the execution time for the slice of the other workload can be smaller than or equal to the length of the periodic execution window T for workload 213.

In some embodiments, two different slice sets, slice set 810 and slice set 820 are provided in FIG. 8A. In some embodiments, scheduler 209 can generate multiple slice sets explicitly or implicitly and compare the cost of executing the multiple slice sets by one or more neural engine circuits of neural processing circuit 218. There can be a predetermined maximum number of slices provided to scheduler 209 so that a slice set can only include a number of slices less than the predetermined maximum number of slices. In addition, a duration of a slice representing a sum of durations for all tasks of the slice can be smaller than a predetermined maximum duration, which can have value T of the length of the periodic execution window of workload 213.

In some embodiments, scheduler 209 can determine that a first portion or amount of the storage device is used for executing a first number of slices of tasks in a first slice set (e.g., slice set 820) by one or more neural engine circuits of a neural processing circuit, where the first amount can be an amount of external memory TF(t) to be allocated for executing task T(t) of a slice of the first slice set. Similarly, scheduler 209 can determine that a second portion or amount of the storage device is used for executing a second number of slices of tasks in a second slice set (e.g., slice set 810) by one or more neural engine circuits of a neural processing circuit. In some embodiments, scheduler 209 can further determine the first slice set (e.g., slice set 820) having the first number of slices of tasks of workload 211 to be sent to neural processing circuit 218 for execution when the first portion of the storage device is smaller than the second portion of the storage device.

In some embodiments, scheduler 209 can determine the first slice set by a dynamic programming algorithm based on the latency L(T(t)) for executing task T(t), the memory move time D(t) for the task T(t), the amount of external memory TF(t), and the amount of external memory XF(t, s) to be allocated for executing the slice S(s) including the task T(t). In some embodiments, dynamic programming is a method for designing algorithms that break down problems into smaller subproblems, solves those subproblems, and then combines the solutions to solve the original problem. Dynamic programming is a mathematical optimization method simplifying a complicated problem by breaking it down into simpler sub-problems in a recursive manner. In some embodiments, to apply the dynamic programming algorithm, for slice S(s), including an ordered list (T(k), . . . , T(t)), a sum of L(T(k))+ . . . +L(T(t)), with the memory move time D(t) can be less than the predetermined maximum duration. In addition, the amount of external memory XF(t, s) to be allocated for executing the slice S(s) including the task T(t) can be determined by a smaller number of the amount of external memory TF(t) and a minimal number of (XF(t, s−1), XF(t−1, s−1), . . . , XF(t−i, s−1)), where a sum of L(T(t−i)) + . . . +L(T(t)) with the memory move time D(t) is less than the predetermined maximum duration. In some embodiments, scheduler 209 can determine the amount of external memory XF(t, s) by a table having (T(1), . . . T(t), . . . , T(n)) as rows of the table, and (S(1), . . . S(s), . . . , S(m)) as columns of the table, where an entry of the table includes a task index for having the minimal number of (XF(t, s−1), XF(t−1, s−1), . . . , XF(t−i, s−1)). Accordingly, the dynamic programming algorithm can determine the amount of external memory XF(t, s) for slice s by using partial solutions of recursively solved slice (s−1) that can include task (t), task (t−1), . . . , or task (t−i). Afterwards, scheduler 209 can determine the ordered list of slices (S(1), . . . S(s), . . . , S(m)) by tracing from an entry of the table at row T(n) and column S(m). Additional details of the table and tracing the table are described below.

In some embodiments, scheduler 209 can determine the slice set, such as slice set 820 offline by a dynamic programming algorithm based on the latency L(T(t)) for executing task T(t), the memory move time D(t) for the task T(t), the amount of external memory TF(t), and the amount of external memory XF(t, s) to be allocated for executing the slice S(s) including the task T(t). Accordingly, the schedule of slice set 820 can be static before the execution of slices of the slice set are performed by neural processing circuit 218. In some embodiments, compiler 207 can first generate the list of tasks (task 211a, task 211b, 211c, 211d, 211e, 211f, 211g, 211h, 211i, 211j, 211k) for workload 211. Afterwards, scheduler 209 can generate various slice sets, determine the costs of the executing the slice sets, and select one slice set to be executed by one or more neural engine circuits (e.g., NE 314A) of neural processing circuit 218. The one or more neural engine circuits of neural processing circuit 218 execute one slice within an execution window for workload 213, switching between a task of workload 213 and a slice of tasks of workload 211 having a priority lower than the priority of workload 213. Hence, the context switching between a slice of workload 211 and a task of workload 213 is enabled by scheduler 209, which can be software enabled according to some embodiments. In some embodiments, scheduler 209 can generate the slice points of the list of tasks (task 211a, task 211b, 211c, 211d, 211e, 211f, 211g, 211h, 211i, 211j, 211k) for workload 211, where a slice point is a task, and a slice is defined by tasks between two slice points. Finally, complier 207 can generate binary code for execution for each slice of tasks based on the slice points generated by scheduler 209. Accordingly, scheduler 209 can schedule a slice of tasks of workload 211 within an execution window for workload 213, where the slice of tasks can include multiple tasks. Operations scheduled by slice for workload 211 can be more efficient than scheduling individual tasks of workload 211. Scheduler 209 generates various slice sets so that neural engine circuits or neural processing circuit 218 can remain stateless without tracking workload 211, but to execute each slice of tasks of workload 211. For neural engine circuits or neural processing circuit 218, a slice of tasks can be treated the same as a smaller workload of workload 211. Compiler 207 and scheduler 209 can ensure that the output generated by a slice of tasks can become the input to the next slice of tasks of workload 211.

In some embodiments, scheduler 209 can consider costs associated with scheduling slices of tasks of workload 211 in determining which slice set to use for executing workload 211. There can be various costs for such scheduling, including external memory footprint used to store the intermediate tensor generated by a slice of tasks into storage 231 of system memory 230 external to neural processing circuit 218, the latency or memory cost needed in the form of clock cycles and energy to move intermediate tensors to and from system memory 230, and the firmware overhead cost associated with scheduler 209. Such costs can be indicated by the memory move time D(t) for task T(t), the amount of external memory TF(t), and the amount of external memory XF(t, s) to be allocated for executing the slice S(s) including the task T(t) as discussed above. In some embodiments, the external memory footprint and the memory cost can be correlated in the sense that, the lower the number of memory footprint bytes are moved, the lower the associated memory costs. The firmware cost can be caused by the operations to switch between workloads and execute lower priority workloads on a slice-by-slice basis while executing the higher priority workload. In some embodiments, scheduler 209 can determine a slice set among many potential slice sets for workload 211 while reducing the total external memory footprint and maintaining the constraints driven by the application for the execution of each workload. In some embodiments, scheduler 209 can determine the optimal points of slicing the lower priority workloads such that the external memory footprint used in the execution of context switching between two or more workloads is minimum while being able to execute the workloads across multiple slices. In some embodiments, scheduler 209 can determine the first slice set by a dynamic programming algorithm based on the latency L(T(t)) for executing task T(t), the memory move time D(t) for the task T(t), the amount of external memory TF(t), and the amount of external memory XF(t, s) to be allocated for executing the slice S(s) including the task T(t).

In some embodiments, scheduler 209 can receive the list of tasks (T(1), . . . T(t), . . . , T(n)) for a workload, a predetermined maximum number of slices(S) allowed, which can be a number determined by use cases or application requirements, and a predetermined maximum duration (D) of each slice in cycles (enforced by length of the inactivity windows of execution windows of workload 213). Given the inputs, scheduler 209 can produce a set of tasks {T(i)} after each a slicing point is inserted, where a slice is defined by two adjacent slicing points. In some embodiments, scheduler 209 can determine the set of tasks {T(i)} that defines the slices to minimize the amount of external memory TF(t), and the amount of external memory XF(t, s) to be allocated for executing the slice S(s) including the task T(t).

In some embodiments, the amount of external memory XF(t, s) can be defined as XF(t, s)=max {TF(t), min{XF(t, s−1), XF(t−1,s−1), . . . , XF(t−i, s−1)}}, such that L(T(t−i−1))+ . . . +L(T(t))+D(t) is less than the predetermined maximum duration (D). In some embodiments, scheduler 209 can use dynamic programming formulation utilized to determine the optimal slice points in the list of tasks for the workload to achieve the least amount of external memory usage. In some embodiments, there can be other assumptions used in the dynamic programming solution, which can include the performing of slicing only after a task, which is a basic unit for execution. In some embodiments, a task cannot be divided into smaller pieces to be scheduled for execution by the one or more neural engine circuits of neural processing circuit 218.

In some embodiments, to apply a dynamic programming algorithm, scheduler 209 can build a table that includes the tasks and slices shown below, where the workload is assumed to include 7 tasks (T1, T2, T3, T4, T5, T6, T7), which can be potentially divided into 6 slices (S1, S2, S3, S4, S5, S6).

TABLE 1

| | A | B | C | D | E | F | G |
|---|---|---|---|---|---|---|---|
| 1 | Tasks/Slice | S1 | S2 | S3 | S4 | S5 | S6 |
| 2 | T1 | V11 | V12 | V13 | V14 | V15 | V16 |
| 3 | T2 | V21 | V22 | V23 | V24 | V25 | V26 |
| 4 | T3 | V31 | V32 | V33 | V34 | V35 | V36 |
| 5 | T4 | V41 | V42 | V43 | V44 | V45 | V46 |
| 6 | T5 | V51 | V52 | V53 | V54 | V55 | V56 |
| 7 | T6 | V61 | V62 | V63 | V64 | V65 | V66 |
| 8 | T7 | V71 | V72 | V73 | V74 | V75 | V76 |

Table 1 can have values Vts, which can also be referred to as V(t, s), such that slice s is done after task t, or alternatively task t is included in slice s. While filling the table, each value Vts in the table is filled based on the following 4 equations:

$$1. [ task\_ind ] for task\_ind in all\_task \_ind \\ i f sum ( L ( t : t - task\_ind ) , D ( t ) ) <= D$$

$$2. XF ( t , s ) = max ( TF ( t ) , min \{ XF ( task\_ind , s - 1 \} )$$

$$3. index = task index with min ( [ XF ( task\_ind , s - 1 ) ] )$$

$$4. V ( t , s ) = [ D ( t ) , XF ( t , s ) , index ]$$

Equation 1 represents that scheduler 209 can consider all valid tasks in the previous slice (s−1) such that the latency of each of the tasks plus the memory cost of moving data out for the current task t, represented by memory move time D(t), is less than the predetermined max duration D of each slice. Accordingly, scheduler 209 can consider a set of tasks that can be potentially included as eligible points at slice (s−1), if slice s is to include task t.

Accordingly, Equation 1 can determine the set of tasks T(t) that are eligible to be included in slice s based on latency constraints. Afterwards, scheduler 209 can evaluate the minimum external memory footprint for the given task t and slice s such that the maximum of the footprint of the current task t and the minimum of the footprints of all valid tasks at slice (s−1) is selected, as represented by Equation 2. In some embodiments, Equation 2 can determine the maximum amount of external memory to be allocated such that the slice s can include task t while considering the minimum footprint of the possible eligible tasks at slice (s−1).

In some embodiments, scheduler 209 can determine the index of the task at slice (s-1) that has the least external memory footprint if task t is included in slice s, as represented by Equation 3.

In some embodiments, each entry Vts in Table 1 can include the memory cost in cycles for task t, which can be represented by memory move time D(ₜ), the minimum external memory footprint determined from Equation 2 and the index determined using Equation 3.

In some embodiments, Table 2 below can be an example on how to provide the entry Vts in Table 1.

TABLE 2

| | A | B | C | D | E | F | G |
|---|---|---|---|---|---|---|---|
| 1 | Tasks/Slice | S1 | S2 | S3 | S4 | S5 | S6 |
| 2 | T1 | V11 | V12 | V13 | V14 | V15 | V16 |
| 3 | T2 | V21 | V22 | V23 | V24 | V25 | V26 |
| 4 | T3 | V31 | V32 | V33 | V34 | V35 | V36 |
| 5 | T4 | V41 | V42 | V43 | V44 | V45 | V46 |
| 6 | T5 | V51 | V52 | V53 | V54 | V55 | V56 |
| 7 | T6 | V61 | V62 | V63 | V64 | V65 | V66 |
| 8 | T7 | V71 | V72 | V73 | V74 | V75 | V76 |

In some embodiments, scheduler 209 can determine the values for entry V22shown in Table 1 above. First, scheduler 209 can determine the set of eligible tasks that can be considered when task 2 is included into slice 2.

$$[ task\_ind ] : latency ( V 22 ) + latency ( V 11 : V 21 ) + D ( T 2 ) \leq D .$$

The equation above shows how the set of eligible tasks are determined. When the above equation is satisfied, the set of eligible tasks can include {T1, T2}. Next, scheduler 209 can calculate the minimum external footprint for V22 by equation:

$$XF ( 2 , 2 ) = max ( TF ( T 2 ) , min ( XF ( 2 , 1 ) , XF ( 1 , 1 ) ) .$$

Based on the above equation, scheduler 209 can determine the value for XF(2,2). Afterwards, scheduler 209 can determine the index of the task that has the least external memory footprint assuming task 2 is included in slice 2.

$$index = T 1 , if XF ( 1 , 1 ) < XF ( 2 , 1 ) ; else T 2.$$

Based on the above equation, the index is stored. Finally, the memory cycles for task D(T2), XF(2,2), and the index are stored at V(2,2).

In some embodiments, as another example, scheduler 209 can determine the values for entry V42 of Table 3 as shown below.

TABLE 3

| | A | B | C | D | E | F | G |
|---|---|---|---|---|---|---|---|
| 1 | Tasks/Slice | S1 | S2 | S3 | S4 | S5 | S6 |
| 2 | T1 | V11 | V12 | V13 | V14 | V15 | V16 |
| 3 | T2 | V21 | V22 | V23 | V24 | V25 | V26 |
| 4 | T3 | V31 | V32 | V33 | V34 | V35 | V36 |
| 5 | T4 | V41 | V42 | V43 | V44 | V45 | V46 |
| 6 | T5 | V51 | V52 | V53 | V54 | V55 | V56 |
| 7 | T6 | V61 | V62 | V63 | V64 | V65 | V66 |
| 8 | T7 | V71 | V72 | V73 | V74 | V75 | V76 |

As detailed above, scheduler 209 can determine the set of tasks that are eligible at slice 1 considering task 4 is included in slice 2:

$$[ task\_ind ] : latency ( V 42 ) + latency ( V 11 : V 41 ) + D ( T 4 ) \leq D .$$

In some embodiments, the above equation may not hold true. At this point, scheduler 209 can omit the farthest task from the previous slice, which is T1, as shown in Table 4 below. Accordingly, scheduler 209 can repeat the check once more as shown below: [task_ind]: latency(V42)+latency(V21: V41)+D(T4)≤D.

TABLE 4

| | A | B | C | D | F | F | G |
|---|---|---|---|---|---|---|---|
| 1 | Tasks/Slice | S1 | S2 | S3 | S4 | S5 | S6 |
| 2 | T1 | V11 | V12 | V13 | V14 | V15 | V16 |
| 3 | T2 | V21 | V22 | V23 | V24 | V25 | V26 |
| 4 | T3 | V31 | V32 | V33 | V34 | V35 | V36 |
| 5 | T4 | V41 | V42 | V43 | V44 | V45 | V46 |
| 6 | T5 | V51 | V52 | V53 | V54 | V55 | V56 |
| 7 | T6 | V61 | V62 | V63 | V64 | V65 | V66 |
| 8 | T7 | V71 | V72 | V73 | V74 | V75 | V76 |

If the above equation is not satisfied, task T2 can be omitted from slice 2 and repeat until scheduler 209 can determine the set of eligible tasks. Once this is obtained, scheduler 209 can repeat the same steps as detailed in the first example and fill the entry V42. A similar process can be done for all the entries in Table 4.

Once complete, to determine the optimal slice points, scheduler 209 can start traversing the table from the last task and last slice. Since the table saves the index of the best cut point at task t and slice s for every entry in the table, the best slice points can be determined by traversing the index values for each of the entries until slice 1 is reached. Finally, the set of tasks at which the optimal slicing is performed is reported to scheduler 209.

In some embodiments, to determine the minimum external memory footprint, scheduler 209 can take the maximum of the XF(t,s) values of the entries being traversed in the table. Finally, scheduler 209 can determine the total memory cost in terms of bytes and cycles being incurred for the given optimal slicing for the workload (completed by adding the memory cost in cycles and bytes for each entry visited in the table while determining the optimal slice points).

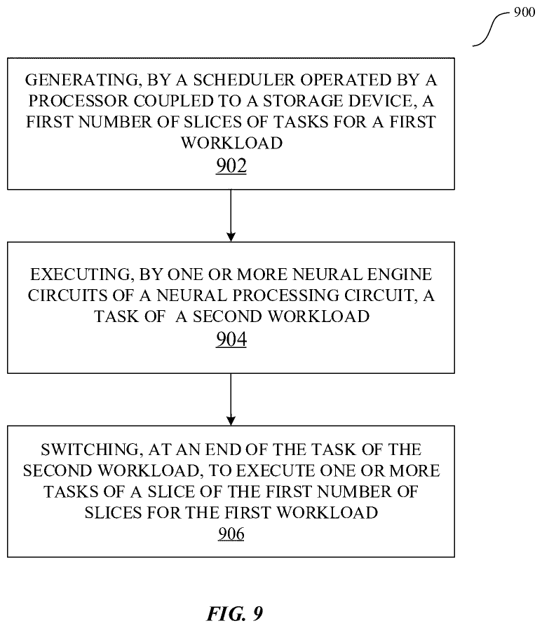

FIG. 9 is a flowchart illustrating a method 900 for a neural processor circuit supporting context switching between tasks of multiple workloads, according to some embodiments. In some embodiments, operations of method 900 can be executed by CPU 208 and/or neural processor circuit 218 of device 100, as shown in FIGS. 2, 3A, and 3B.

In some embodiments, at 902, scheduler 209 can generate a first number of slices of tasks for a first workload, such as the number of slices in slice set 820 for workload 211. A slice of the first number of slices can include one or more tasks of workload 211. In some embodiments, there are 3 slices in slice set 820, while a predetermined maximum number of slices for workload 211 can be 6 that is larger than the 3 slices in slice set 820. For each slice, such as slice 823, slice 825, and slice 827 of slice set 820, a duration of the slice can represent a sum of durations for all tasks of the slice. A duration of a task can be a latency L(T(t)) for executing the task T(t). In some embodiments, a duration of the slice for each slice of slice set 820 can be smaller than a predetermined maximum duration. In some embodiments, a first portion or amount of storage device 231 can be used for executing the first number of slices of tasks by one or more neural engine circuits of neural processing circuit 218. In some embodiments, scheduler 209 can determine a second portion of storage device 231 for executing a second number of slices of tasks of workload 211 in response to the tasks of workload 211 being divided into the second number of slices, such as slice set 810. Scheduler 209 can generate and select slice set 820 for execution instead of slice set 810 when the first portion of storage device 231 used for executing slice set 820 is smaller than a second portion of storage device 231 for executing slice set 810.

In some embodiments, at 904, one or more neural engine circuits of neural processing circuit 218 can execute a task (e.g., task 213a) of workload 213 that has a higher priority than workload 211.

In some embodiments, at 906, at an end of the task of workload 213, the one or more neural engine circuits of neural processing circuit 218 can switch to execute the one or more tasks of a slice (e.g., slice 823) of the first number of slices of slice set 820.

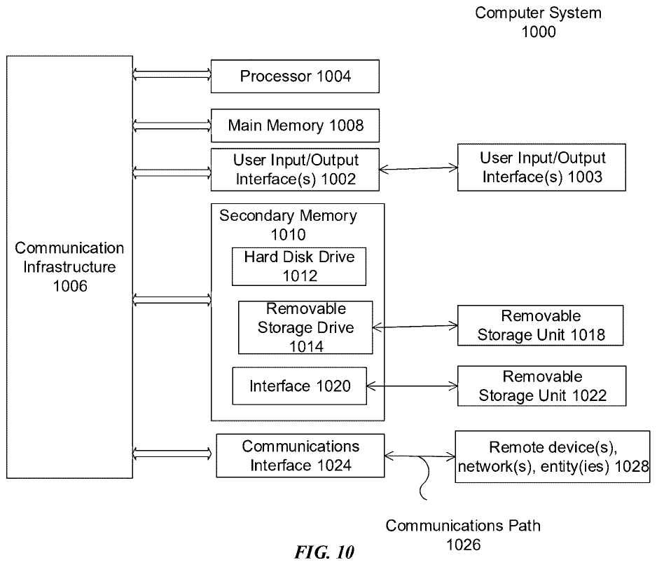

FIG. 10 is an illustration of an example computer system for implementing some embodiments or portion(s) thereof of the disclosure provided herein, according to some embodiments.

Various embodiments can be implemented, for example, using one or more computer systems, such as computer system 1000 shown in FIG. 10. Computer system 1000 can be any computer capable of performing the functions described herein for CPU 208, neural processor circuit 218, neural engine 314 as shown in FIGS. 2, 3A, 3B, and 8A-8C. Computer system 1000 includes one or more processors (also called central processing units, or CPUs), such as a processor 1004. Processor 1004 is connected to a communication infrastructure 1006 (e.g., a bus). Computer system 1000 also includes user input/output device(s) 1003, such as monitors, keyboards, and pointing devices, that communicate with communication infrastructure 1006 through user input/output interface(s) 1002. Computer system 1000 also includes a main or primary memory 1008, such as random access memory (RAM). Main memory 1008 may include one or more levels of cache. Main memory 1008 has stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (e.g., control logic) and/or data. Removable storage unit 1018 may be a floppy disk, magnetic tape, compact disk, DVD, optical storage disk, and/any other computer data storage device. Removable storage drive 1014 reads from and/or writes to removable storage unit 1018 in a well-known manner.

According to some embodiments, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (e.g., an interface found in video game devices), a removable memory chip (e.g., an EPROM or PROM) and associated socket, a memory stick and USB port, a memory card and associated memory card slot, and/or any other removable storage unit and associated interface.

In some examples, main memory 1008, the removable storage unit 1018, the removable storage unit 1022 can store instructions that, when executed by processor 1004, cause processor 1004 to perform operations for CPU 208, neural processor circuit 218, neural engine 314 as shown in FIGS. 2, 3A, 3B, and 8A-8C.

Computer system 1000 may further include a communication or network interface 1024. Communication interface 1024 enables computer system 1000 to communicate and interact with any combination of remote devices, remote networks, remote entities, and other suitable devices (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, and any other suitable networks. Control logic and/or data may be transmitted to and from computer system 1000 via communication path 1026.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (e.g., software) stored thereon is also referred to as a “computer program product” or “program storage device.” This includes, but is not limited to, computer system 1000, main memory 1008, secondary memory 1010 and removable storage units 1018 and 1022, as well as tangible articles of manufacture embodying any combination of the foregoing. Such control logic, when executed by one or more data processing devices (e.g., computer system 1000), causes such data processing devices to operate as described herein.

Based on the teachings in this disclosure, it will be apparent to persons skilled in the relevant art(s) how to make and use embodiments of the disclosure using data processing devices, computer systems and/or computer architectures other than that shown in FIG. 10. In particular, embodiments may operate with software, hardware, and/or operating system implementations other than those described herein.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of. . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature do not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation—[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits may result in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A system, comprising:
a storage device comprising a first portion and a second portion;
a processor coupled to the storage device; and
a scheduler configured to be operated by the processor and to:
receive a plurality of tasks of a first workload;
generate a first number of slices of tasks for the plurality of tasks of the first workload,
wherein a slice of the first number of slices comprises one or more tasks of the plurality of tasks, the first number is smaller than a predetermined maximum number of slices, and a duration of the slice representing a sum of durations for all tasks of the slice is smaller than a predetermined maximum duration,
wherein the first portion of the storage device is used for executing the first number of slices of tasks by one or more neural engine circuits of a neural processing circuit, the first portion of the storage device is smaller than the second portion of the storage device for executing a second number of slices of tasks of the first workload in response to the plurality of tasks of the first workload being divided into the second number of slices,
wherein the second number is smaller than the predetermined maximum number of slices, and a duration of a slice of the second number of slices is smaller than the predetermined maximum duration, and
wherein the predetermined maximum duration is determined before the scheduler is configured to generate the first number of slices of tasks, and
wherein the one or more neural engine circuits of the neural processing circuit are configured to:
execute a task of a plurality of tasks of a second workload; and
switch, at an end of the task of the second workload, to execute the one or more tasks of the slice of the first number of slices.

2. The system of claim 1, further comprising a compiler configured to be operated by the processor and to generate the plurality of tasks of the first workload.

3. The system of claim 1, wherein the first workload has a first priority and the second workload has a second priority higher than the first priority.

4. The system of claim 1, wherein:
the task of the plurality of tasks of the second workload is executed within a periodic execution window for the second workload, and
the one or more tasks of the slice of the first workload are executed within the periodic execution window for the second workload,
the task of the second workload has a second execution time,
the one or more tasks of the slice of the first workload have a first execution time, and
a sum of the first execution time and the second execution time is smaller than or equal to a length of the periodic execution window for the second workload.

5. The system of claim 4, wherein the one or more neural engine circuits of the neural processing circuit are further configured to:
execute one or more tasks of a third workload for a third execution time after executing the one or more tasks of the slice of the first workload, wherein a sum of the first execution time, the second execution time, and the third execution time is smaller than or equal to the length of the periodic execution window for the second workload, and wherein the first workload has a first priority, the third workload has a third priority, and the second workload has a second priority higher than the first priority and the third priority.

6. The system of claim 4, wherein the periodic execution window is a first periodic execution window for the second workload, the task of the second workload is a first task of the second workload, the slice of the first workload is a first slice, and wherein the one or more neural engine circuits of the neural processing circuit are further configured to:
execute a second task of the plurality of tasks of the second workload; and
switch, at an end of the second task of the second workload, to execute one or more tasks of a second slice of the first number of slices of the first workload.

7. The system of claim 6, wherein the one or more neural engine circuits of the neural processing circuit comprise an internal storage device configured to store an output generated by executing a task of the one or more tasks of the first slice of the first workload.

8. The system of claim 6, wherein the one or more neural engine circuits of the neural processing circuit are further configured to execute the first number of slices of the first workload within the first number of periodic execution window for the second workload, wherein one slice of the first workload is executed within one periodic execution window for the second workload.

9. The system of claim 6, wherein an output generated by the one or more neural engine circuits executing the first slice of the first workload is stored in a storage device external to the neural processing circuit, and wherein the output generated by one or more neural engine circuits executing the first slice of the first workload is provided as an input for executing the second slice of the first workload.

10. A method performed by a system, comprising:
generating, by a scheduler operated by a processor coupled to a storage device, a first number of slices of tasks for a plurality of tasks of a first workload,
wherein a slice of the first number of slices comprises one or more tasks of the plurality of tasks, the first number is smaller than a predetermined maximum number of slices, and a duration of the slice representing a sum of durations for all tasks of the slice is smaller than a predetermined maximum duration,
wherein a first portion of the storage device is used for executing the first number of slices of tasks by one or more neural engine circuits of a neural processing circuit, the first portion of the storage device is smaller than a second portion of the storage device for executing a second number of slices of tasks of the first workload in response to the plurality of tasks of the first workload being divided into the second number of slices;
executing, by the one or more neural engine circuits of the neural processing circuit, a task of a plurality of tasks of a second workload; and
switching, at an end of the task of the second workload, to execute the one or more tasks of the slice of the first number of slices.

11. The method of claim 10, wherein the plurality of tasks of the first workload comprise an ordered list of tasks (T(1), . . . T(t), . . . , T(n)), a task T(t) of the ordered list of tasks having an associated task rank t in an increasing order defined by natural numbers {1, . . . , t, . . . , n}, wherein the ordered list of tasks is divided into an ordered list of slices (S(1), . . . S(s), . . . , S(m)), a slice S(s) of the ordered list of slices having an associated slice rank s in the increasing order defined by natural numbers, a previous slice S(s−1) comprises a set of tasks (T(t1), . . . , T(t2)), and a current slice S(s) comprises a set of tasks (T(t2+1), . . . , T(t3)), where t1, t2, and t3 are natural numbers satisfying t1≤t2<t3.

12. The method of claim 11, further comprising:
determining whether the task T(t) is included in the slice S(s) based on a latency L(T(t)) for executing the task T(t) by the one or more neural engine circuits of the neural processing circuit, a memory move time D(t) for moving data out of the neural processing circuit to the storage device for the task T(t), an amount of external memory TF(t) to be allocated for executing the task T(t), and an amount of external memory XF(t, s) to be allocated for executing the slice S(s) including the task T(t).

13. The method of claim 12, wherein the first number of slices of tasks of the first workload are determined by a dynamic programming algorithm based on the latency L(T(t)) for executing the task T(t), the memory move time D(t) for the task T(t), the amount of external memory TF(t), and the amount of external memory XF(t, s) to be allocated for executing the slice S(s) including the task T(t).

14. The method of claim 13, wherein the slice S(s) includes an ordered list (T(k), . . . , T(t)), where a sum of L(T(k))+ . . . +L(T(t)) with the memory move time D(t) is less than the predetermined maximum duration.

15. The method of claim 14, wherein the amount of external memory XF(t, s) to be allocated for executing the slice S(s) including the task T(t) is determined by a smaller number of the amount of external memory TF (t) and a minimal number of {XF(t, s−1), XF(t−1, s−1), . . . , XF(t−i, s−1)), where a sum of L(T(t−i))+ . . . +L(T(t)) with the memory move time D(t) is less than the predetermined maximum duration.

16. The method of claim 15, further comprising:
determining the amount of external memory XF(t, s) by a table having (T(1), . . . T(t), . . . , T(n)) as rows of the table and (S(1), . . . S(s), . . . , S(m)) as columns of the table, where an entry of the table includes a task index for having the minimal number of {XF(t, s−1), XF(t−1, s−1), . . . , XF(t−i, s−1)).

17. The method of claim 16, further comprising:
determining the ordered list of slices (S(1), . . . S(s), . . . , S(m)) by tracing from an entry of the table at row T(n) and column S(m).

18. A system, comprising:
a storage device;
a neural processing circuit comprising one or more neural engine circuits;
a processor coupled to the storage device and the neural processing circuit; and
a scheduler configured to be operated by the processor and to generate a first number of slices of tasks for the plurality of tasks of the first workload,
wherein a slice of the first number of slices comprises one or more tasks of the plurality of tasks, the first number is smaller than a predetermined maximum number of slices, and a duration of the slice representing a sum of durations for all tasks of the slice is smaller than a predetermined maximum duration,
wherein a first amount of the storage device is used for executing the first number of slices of tasks by the one or more neural engine circuits of the neural processing circuit, the first amount of the storage device is smaller than a second amount of the storage device for executing a second number of slices of tasks of the first workload in response to the plurality of tasks of the first workload being divided into the second number of slices;
wherein the one or more neural engine circuits of the neural processing circuit are configured to:
execute a task of a plurality of tasks of a second workload; and
switch, at an end of the task of the second workload, to execute the one or more tasks of the slice of the first number of slices.

19. The system of claim 18, further comprising a compiler configured to be operated by the processor and to generate the plurality of tasks of the first workload, wherein the first workload has a first priority and the second workload has a second priority higher than the first priority.

20. The system of claim 18, wherein:
the task of the plurality of tasks of the second workload is executed within a periodic execution window for the second workload,
the one or more tasks of the slice of the first workload are executed within the periodic execution window for the second workload,
the task of the second workload has a second execution time,
the one or more tasks of the slice of the first workload have a first execution time, and
a sum of the first execution time and the second execution time is smaller than or equal to a length of the periodic execution window for the second workload.
